(19) United States
(12) Patent Application Publication
(10) Pub. No.: US 2014/0110389 A1
(43) Pub. Date: Apr. 24, 2014

(54) HEATING DEVICE HAVING A REMOVABLE AROMA MATERIAL CONTAINER FOR AN AROMA MATERIAL TO BE CONTAINED THEREIN

(71) Applicant: Ming Jen Hsiao, Road Town (VG)

(72) Inventor: Ming Jen Hsiao, Road Town (VG)

(73) Assignee: SERENE HOUSE INTERNATIONAL ENTERPRISE LTD.

(21) Appl. No.: 13/658,820

(22) Filed: Oct. 24, 2012

(51) Int. Cl. F27D 11/00

(52) U.S. Cl. 219/385

(57) ABSTRACT

A heating device having a removable aroma material container is provided, including a receiving unit, a removable aroma material container having a scented wax contained therein, and an air ventilation film covering an opening of the container. A sealing cover covers the air ventilation film and the opening to seal the scented wax in the container. A user is allowed to lift the sealing cover and places the container in the receiving unit, and the scented wax is heated by the heating device to disperse scent. If the heating device and the container are toppled by chance, the melted scented wax is blocked by the air ventilation film from flowing to a region outside of the heating device. The container is disposable or recyclable as the scented wax burns out. An LED in the heating device emits light penetrating the receiving unit. The heating device is safe and good-to-see.

### CROSS-REFERENCES TO RELATED APPLICATIONS

Two pending new applications Ser. Nos. 13/549,490 and 13/549,493 filed on Jul. 15, 2012 are hereby incorporated by reference.

### BACKGROUND OF THE INVENTION

1. Field of the Invention

This invention relates to heating devices that heat aroma block, and, more particularly, to a heating device that has a removable aroma material container for an aroma material to be contained therein.

2. Description of Related Art

In modern society, people are becoming to use aroma material products (e.g., essential oil or aroma block such as scented wax), in order to pure or fresh air or enhance the ambience or mood in the home or workplace. In use, the scented wax is taken out from a container and placed in a receiving space of a heating device. The heating device is then supplied with power and generates heat, which will melt the aroma block gradually and facilitate the dispersal of scent therefrom.

However, the above use of the aroma block has the following drawbacks. A user has to prepare a certain container for containing the aroma block. The user is required to take the aroma block out from the container and place the aroma block in the receiving space of the heating device carefully, in order not to be stained by the aroma block. After the aroma block is melt and evaporated into the air completely, the user has to clean and wash the receiving space, or another aroma block having different scent from that of the previous aroma block will be blended with the previous aroma block and disperse unexpected scent. The receiving space, if made of a fragile material such as a ceramic product, is likely broken if not being washed carefully.

The minute and complicated washing and cleaning processes of the conventional heating device turn the aroma material products that should have pleases people in daily life into troublesome products. Therefore, how to overcome the above drawbacks of the conventional heating device is becoming one of the popular issues in the art.

### SUMMARY OF THE INVENTION

In view of the above-mentioned problems of the prior art, the present invention provides a heating device having a removable aroma material container for an aroma material to be contained therein, including: a a housing; a bottom cover disposed on a bottom of the housing; a power circuit board disposed on the bottom cover; a supporting pole having a bottom end disposed on the bottom cover; a protection cover supported by a top end of the supporting pole; a resistor placed on the protection cover and electrically connected to the power circuit board for generating heat; a receiving unit including a heat conductive unit disposed at an inner side thereof, the heat conductive unit having one side in contact with the resistor; a removable aroma material container placed in the receiving unit for an aroma material to be contained therein; and a top cover disposed on a top of the housing and covering the removable aroma material container, the receiving unit, the resistor and the protection cover in the housing, the top cover having an air vent.

In an embodiment, the removable aroma material container includes an air ventilation film that covers an opening of the removable aroma material container and the aroma material contained in the removable aroma material container. A sealing cover further covers the air ventilation film and the opening to seal the scented wax in the removable aroma material container. A user is allowed to lift the sealing cover and place the removable aroma material container in the receiving unit, and the aroma material is heated and melted to disperse scent. If the heating device and the removable aroma material container are toppled by change, the melted scented wax is blocked by the air ventilation film from flowing to a region outside of the heating device. The heating device is safe to use. In an embodiment, the removable aroma material container is a metal removable aroma material container that is not fragile, and is disposable or recyclable as the scented wax burns out. In an embodiment, the receiving unit is made a material pervious to light, and an LED in the heating device emits light penetrating the receiving unit. The heating device is good to see.

### BRIEF DESCRIPTION OF DRAWINGS

The invention can be more fully understood by reading the following detailed description of the preferred embodiments, with reference made to the accompanying drawings, wherein:

FIG. 1 is an exploded view of a heating device having a removable aroma material container for an aroma material to be contained therein of a first embodiment according to the present invention;

FIG. 2A-2E are a left-side view, a cross-sectional view along a line AA of the left-side view, a top view, a bottom view and a right-side view of the heating device shown in FIG. 1, respectively;

FIG. 3 is an exploded view of a heating device having a removable aroma material container for an aroma material to be contained therein of a second embodiment according to the present invention;

FIGS. 4A and 4B are a cross-sectional view and a schematic view of the heating device shown in FIG. 3, respectively;

FIG. 5 is an exploded view of a heating device having a removable aroma material container for an aroma material to be contained therein of a third embodiment according to the present invention; and

FIGS. 6A and 6B are a cross-sectional view and a schematic view of the heating device shown in FIG. 5, respectively.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

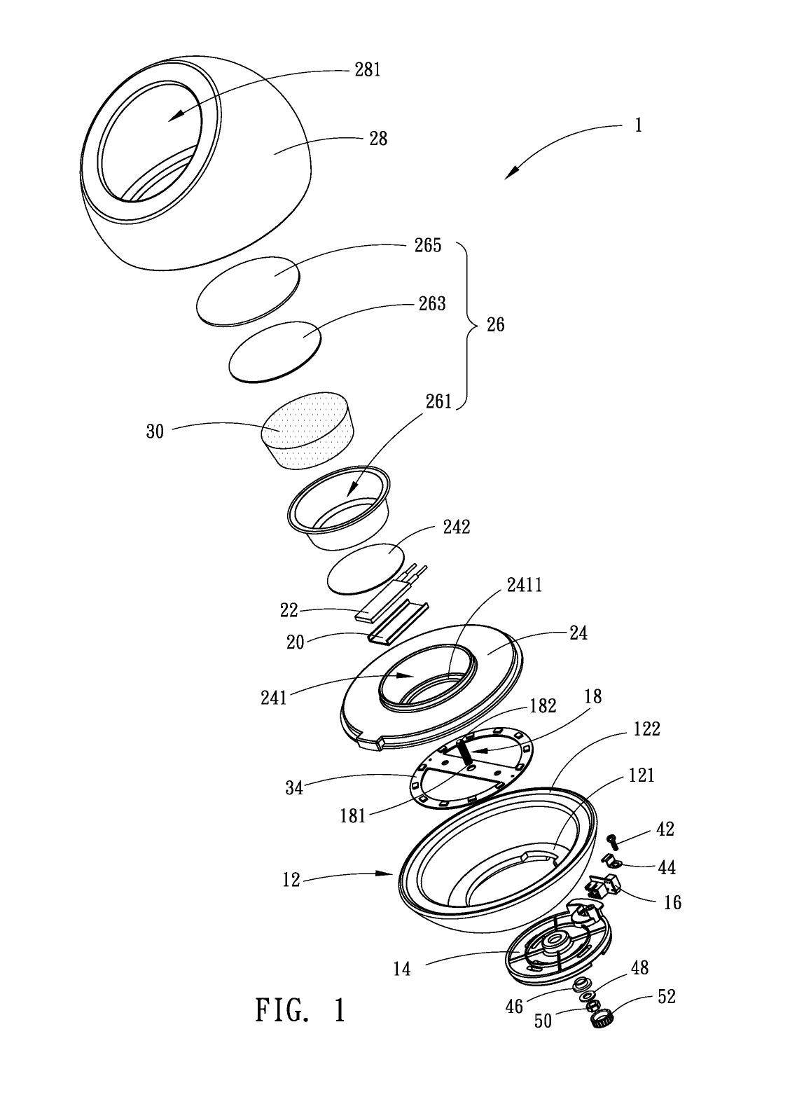

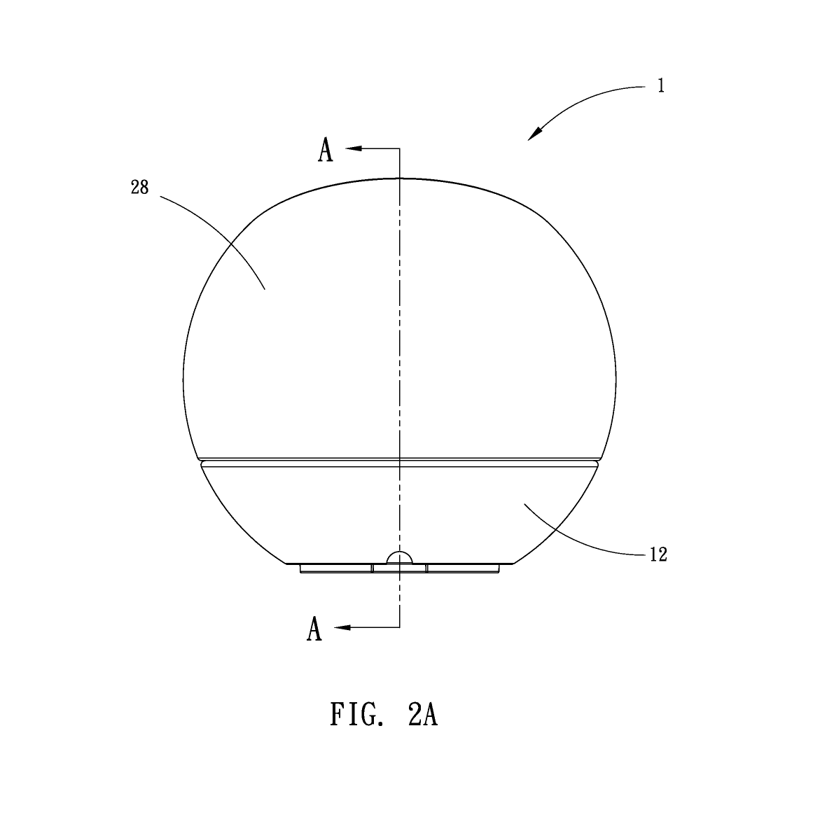

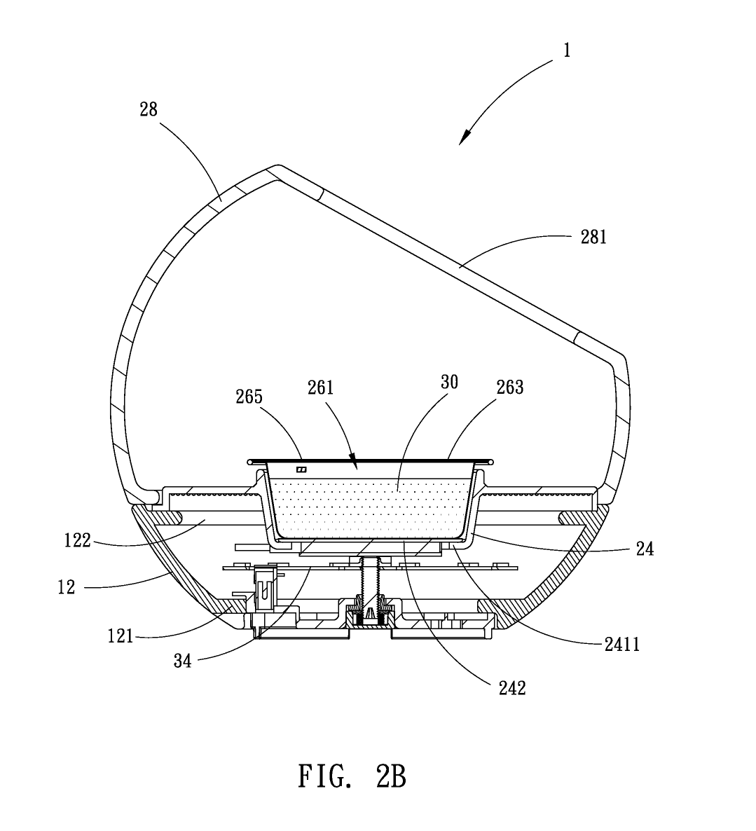

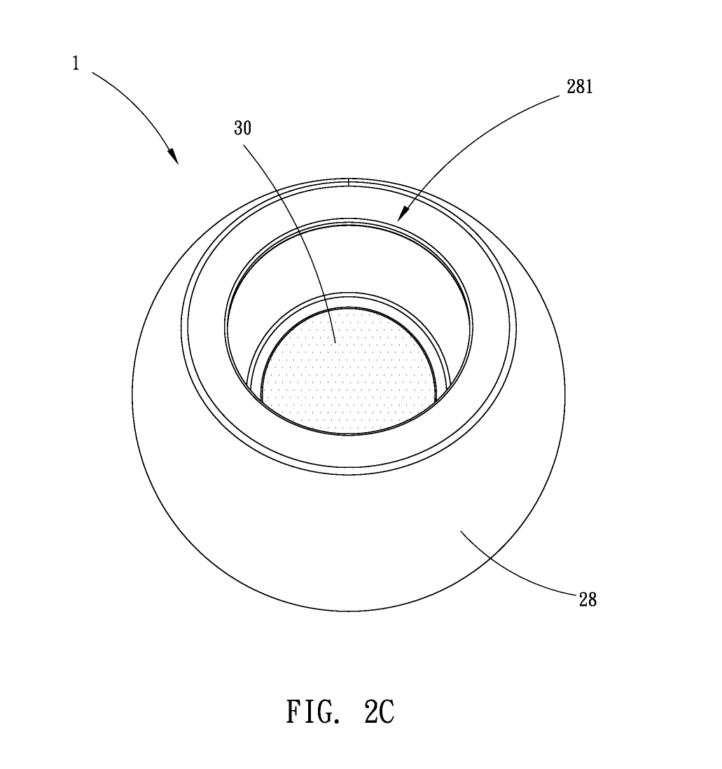

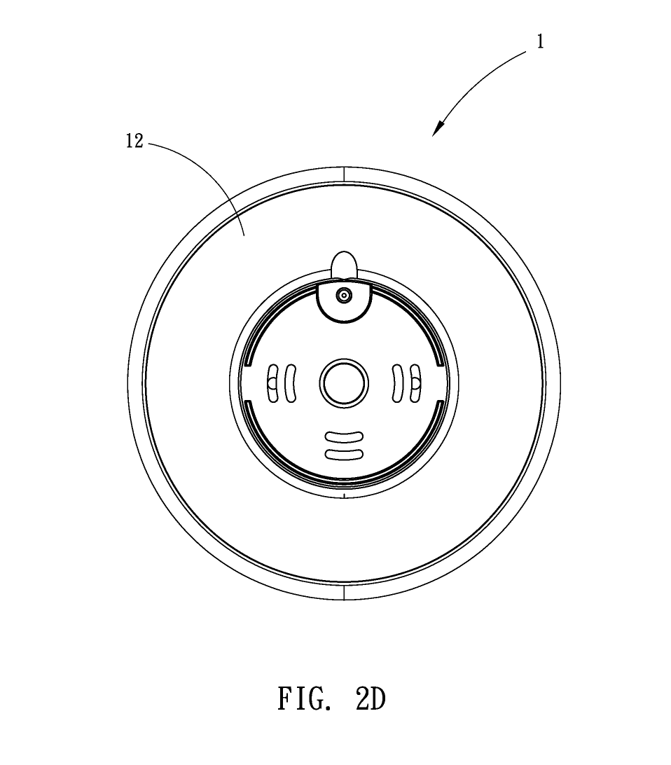

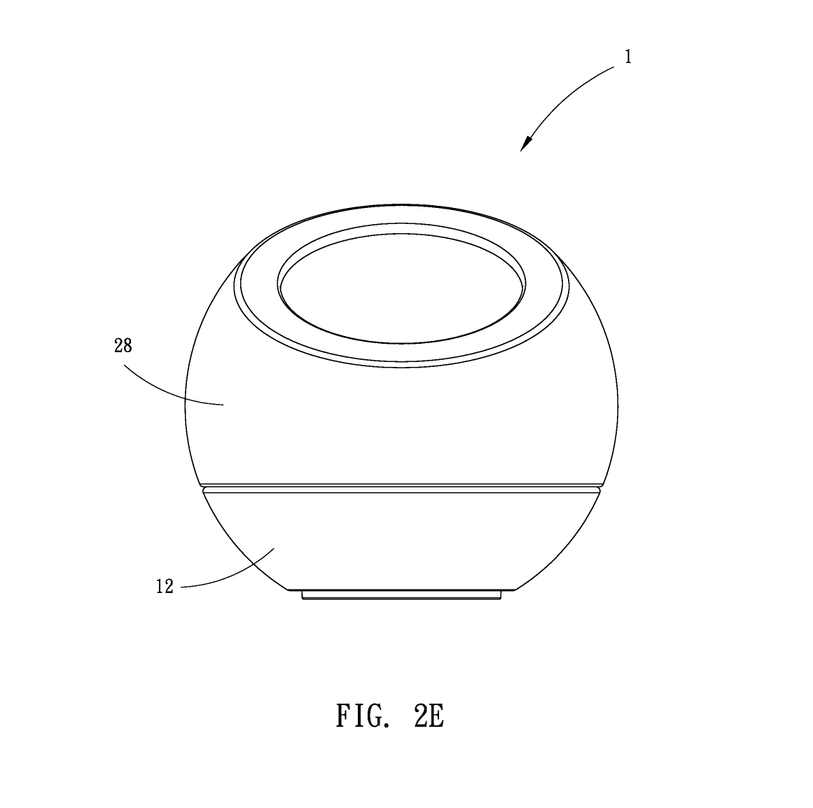

Please refer to FIGS. 1 and 2A-2E, which are an exploded view of a heating device 1 having a removable aroma material container for an aroma material to be contained therein of a first embodiment according to the present invention, and a left-side view, a cross-sectional view along a line AA of the left-side view, a schematic view, a bottom view and a right-side view of the heating device 1, respectively.

The heating device 1 comprises a housing 12, a bottom cover 14 disposed on a bottom 121 of the housing 12, a power circuit board 16 disposed on the bottom cover 14, a supporting pole 18 having a bottom end 181 installed on the bottom cover 14, a protection cover 20 supported by a top end 182 of the supporting pole 18, a resistor 22 placed on the protection cover 20 and electrically connected to the power circuit board 16, and a receiving unit 24 having a heat conductive unit 242 disposed at an inner side thereof, the heating conductive unit 242 having one side in contact with one side of the resistor 22. The heating device 1 further comprises a removable aroma material container 26 in contact with the other side of the resistor 22, and a top cover 28 disposed on a top of the housing 12 and covering the removable aroma material container 26, the receiving unit 24, the resistor 22 and the protection cover 20 in the housing 12.

In an embodiment, the removable aroma material container 26 further includes an aroma block 30, an air ventilation film 263 covering an opening 261 of the removable aroma material container 26 and the aroma block 30, and a sealing cover 265 sealing the opening 261 of the removable aroma material container 26 to seal the aroma block 30 and the air ventilation film 263 in the removable aroma material container 26.

In an embodiment, the resistor 22 is a positive thermal coefficient (PTC) resistor that generates heat. Therefore, when power is supplied to the power circuit board 16, the resistor 22 electrically connected to the power circuit board 16 generates heat, which melts the aroma block 30, and the melted aroma block 30 disperses aroma into the ambient.

In general, the aroma block 30 melts and disperses scent at 35-75° C. In an embodiment, the aroma block 30 is a scented wax. The resistor 22 heats the scented wax up to 35-75° C. at which an aroma material bought in the market is heated and disperses scent into the ambient. Correspondingly, the receiving unit 24 and the removable aroma material container 26 are made of a material that is not melted or deformable at 35-75° C., and can conduct the heat generated by the resistor 22 to the aroma block 30. In an embodiment, the receiving unit 24 and the removable aroma material container 26 are made of metal, hard plastic, a fiber bowel composite material (e.g., plant fibers such as corn fibers, glass fiber or carbon fibers). In an embodiment, the removable aroma material container 26 is made of metal such as foil. Therefore, the removable aroma material container 26 is thin and light, and has a well enough heat conduction capability to conduct the heat generated by the resistor 22 to the aroma block 30 to facilitate the dispersal of scent therefrom. Besides, the aluminum-foiled removable aroma material container 26 is tough and unlikely to be broken, as compared with the ceramic or glass bowls that are used by the conventional device to contain essential oil. Moreover, the sealing cover 265 seals the aroma block 30 or other types of aroma material products in the aluminum-foiled removable aroma material container 26, to control the quality of the aroma material.

Since the aroma block 30 is placed in the removable aroma material container 26, rather than placed in other types of containers, a user, when using the aroma block 30, can lift the sealing cover 265 off, without worrying being stained by the aroma block 30. As the aroma block 30 is heated in the heating device 1 and evaporated completely, the user can replace the removable aroma material container 26 with a new removable aroma material container in which a new aroma block is contained and disperses scent the same as or different that of the aroma block 30. In other words, the user does not need to wash and clean the removable aroma material container 26 or worries about the new aroma block will disperse unexpected scent. Besides, since the removable aroma material container 26 is made of an aluminum foil, the user needs not worry about washing or breaking the removable aroma material container 26, or prepare a specific container to contain the aroma block 30.

In an embodiment of a heating device having a removable aroma material container for an aroma material to be contained therein, the air ventilation film 263 comprises an air vent for guiding the scent of the scented wax upward into the ambient. In an embodiment, the air ventilation film 263 is a fabric film, a fiber film, a perforated film or a perforated metal foil. A user is allowed to lift the sealing cover 265 conveniently, and place the removable aroma material container 26 in the receiving unit 24. The aroma block 30 is heated by the heating device 1 and disperses scent. It the heating device 1 and the removable aroma material container 26 are toppled by chance, the melted scented wax 30 is blocked by the air ventilation film 263 from flowing to a region outside of the heating device 1. The heating device is thus safe to use.

In an embodiment, the receiving unit 24 comprises a receiving space 241 and an inner flange 2411 disposed on a bottom side of the receiving space 241. The heat conductive unit 242 is disposed on the inner flange 2411.

In an embodiment, the heating device 1 further comprises a light emitting diode circuit board 34 and a light guiding ring 36. The light emitting diode circuit board 34 is mounted on the supporting pole 18 and electrically connected to the power circuit board 16 for emitting light. In an embodiment, the receiving unit 24 and the top cover 28 are made of a material pervious to light, including transparent or translucent plastic, acrylic, glass and light-pervious ceramics. The receiving unit 24 is mounted on the light emitting diode circuit board 34 and is covered by the top cover 28. The top cover 28 is made of a material pervious to light, and has an air vent 281 (or a light vent) for dispersing the aroma of the aroma 30 into the ambient. The light emitting diode circuit board 34 includes a light emitting diode that emits light penetrating the receiving unit 24. Therefore, a specific pattern that is good to see is shown on the top cover 28.

In an embodiment, the heating device 1 further comprises a screw 42, a fixing washer 44, a thermal insulation glue 46, a washer 48, a nut 50, and a silicone plug 52.

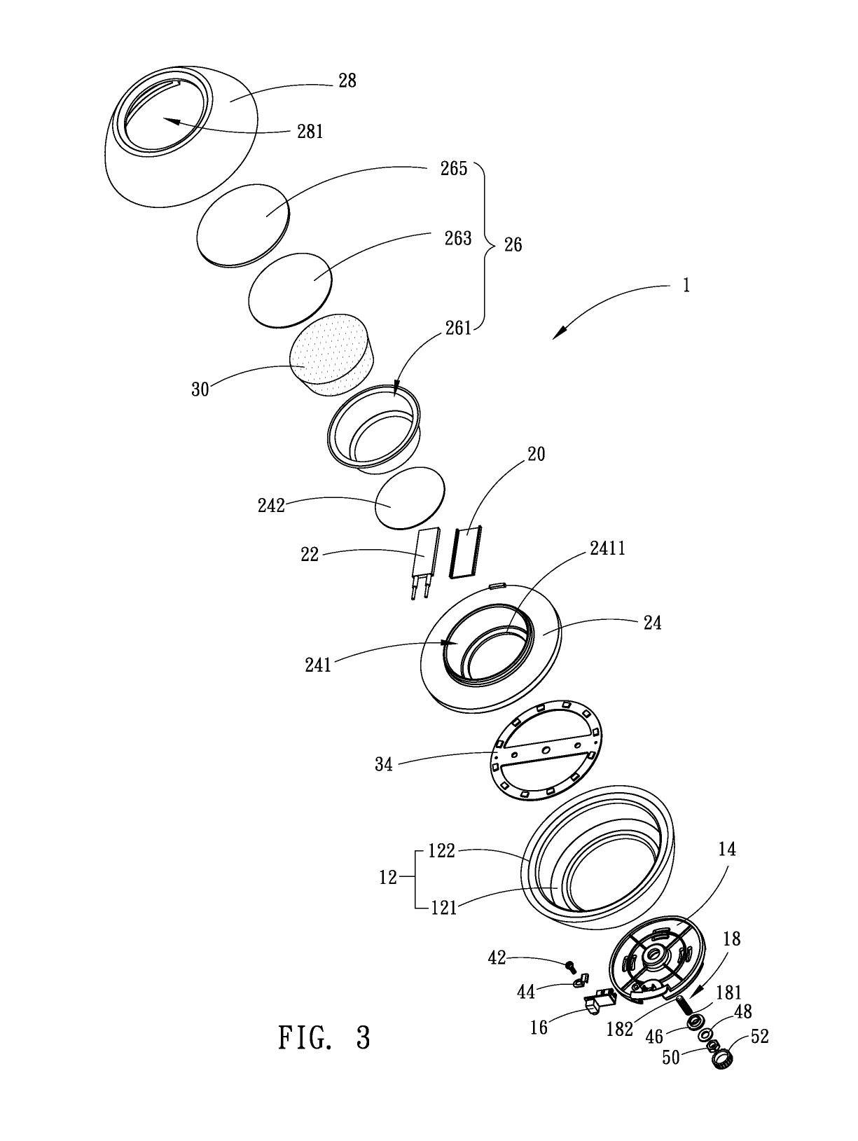

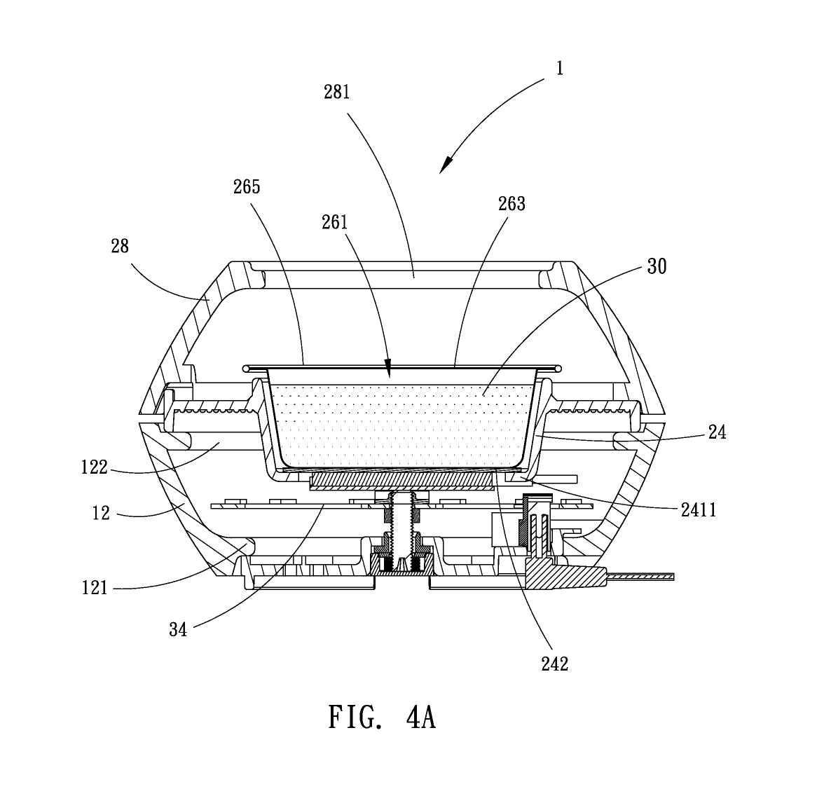

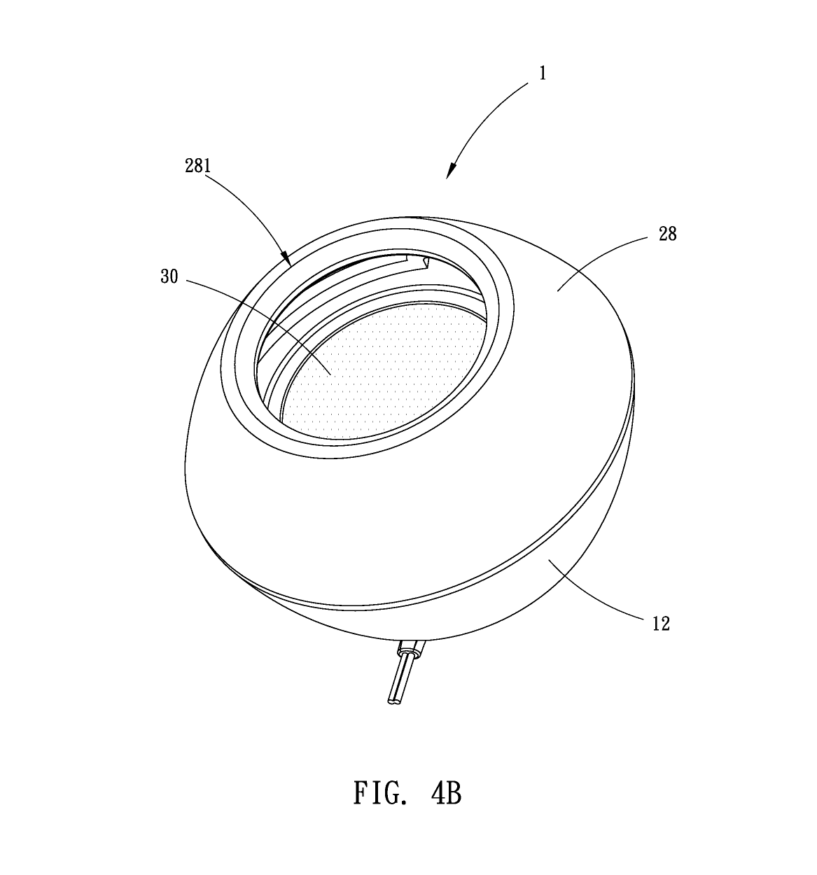

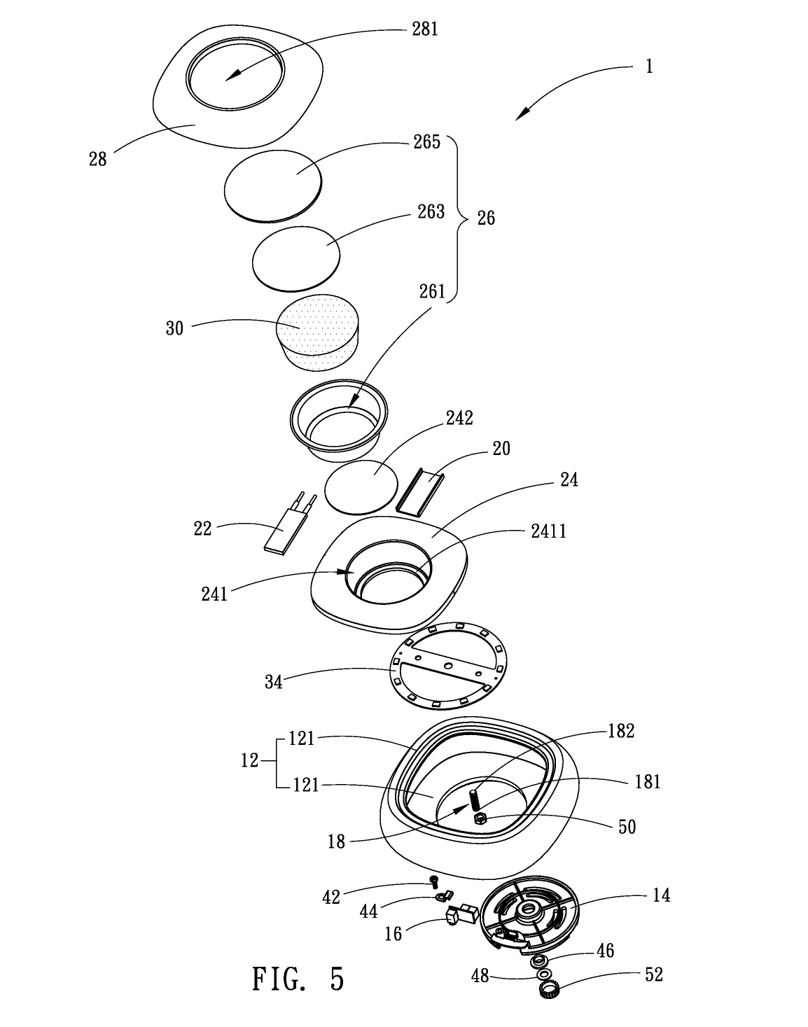

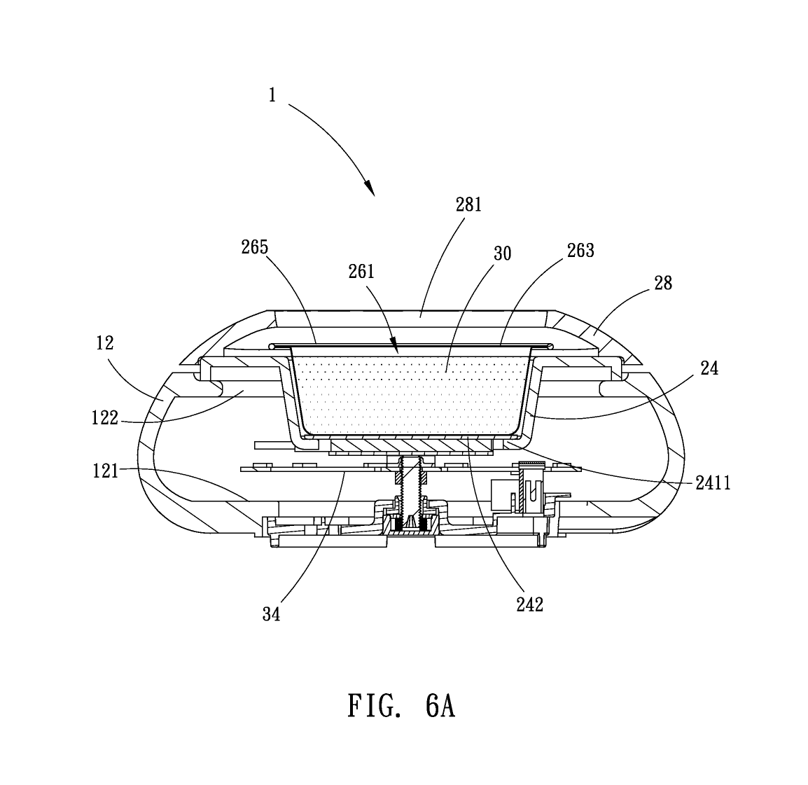

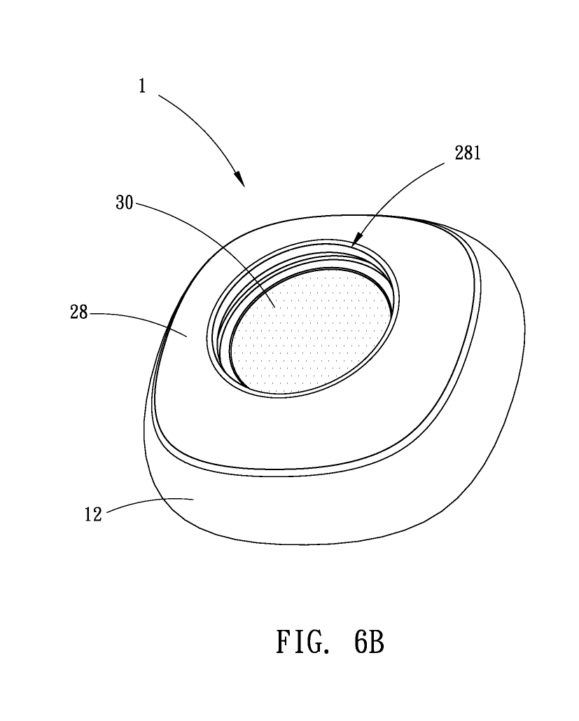

Referring to FIGS. 3, 4A and 4B, shown are an exploded view, a cross-sectional view and a schematic view of the heating device having a removable aroma material container for an aroma material to be contained therein of a third embodiment according to the present invention, respectively. Referring to FIGS. 5, 6A and 6B, shown are an exploded view, a cross-sectional view and a schematic view of a heating device having a removable aroma material container for an aroma material to be contained therein of a third embodiment according to the present invention, respectively. The second and third embodiments differ from the first embodiment in the shapes of the housing 12 and the top cover 28.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

1-10. (canceled)

11. A heating device, comprising:
a housing;
a bottom cover disposed on a bottom of the housing;
a power circuit board disposed on the bottom cover;
a supporting pole having a bottom end disposed on the bottom cover;
a protection cover supported by a top end of the supporting pole;
a resistor placed on the protection cover and electrically connected to the power circuit board for generating heat; and
a receiving unit including a heat conductive unit disposed at an inner side thereof, the heat conductive unit having one side in contact with the resistor.

12. The heating device of claim 11, further comprising a removable aroma material container placed in the receiving unit for accommodating an aroma material.

13. The heating device of claim 12, further comprising a top cover disposed on a top of the housing and covering the removable aroma material container, the receiving unit, the resistor and the protection cover in the housing, the top cover comprising an air vent.

14. The heating device of claim 13, further comprising a light emitting diode circuit board mounted on the supporting pole and electrically connected to the power circuit board for emitting light, wherein the receiving unit or the top cover is made of a transparent material, and the receiving unit covers the light emitting diode circuit board and is covered by the top cover.

15. The heating device of claim 12, wherein the removable aroma material container further comprises an air ventilation film covering the removable aroma material container to block the aroma material in the removable aroma material container.

16. The heating device of claim 15, wherein the air ventilation film is a fabric film, a fiber film, a perforated film or a perforated metal foil.

17. The heating device of claim 12, wherein the removable aroma material container is made of metal, plastic or a composite material.

18. The heating device of claim 17, wherein the metal removable aroma material container is an aluminum foil bowl.

19. The heating device of claim 12, wherein the aroma material is a scented wax.

20. The heating device of claim 12, wherein the receiving unit comprises a receiving space having an inner flange, the heat conductive unit is disposed on an inner flange of the receiving space, and the removable aroma material container is placed on the heat conductive unit.

21. The heating device of claim 11, wherein the heat conductive unit is a metal heat conductive unit.

22. The heating device of claim 11, further comprising a top cover disposed on a top of the housing and covering the receiving unit, the resistor and the protection cover in the housing, the top cover comprising an air vent.

23. The heating device of claim 22, further comprising a light emitting diode circuit board mounted on the supporting pole and electrically connected to the power circuit board for emitting light, wherein the receiving unit or the top cover is made of a transparent material, and the receiving unit covers the light emitting diode circuit board and is covered by the top cover.
